(19) United States
(12) Patent Application Publication
(10) Pub. No.: US 2025/0238886 A1
(43) Pub. Date: Jul. 24, 2025

(54) Incentivized Youth Education System

(71) Applicant: CONSUMERON, LLC, Los Angeles, CA (US)

(72) Inventor: Mark B. BARRON, Bel Air, CA (US)

(73) Assignee: CONSUMERON, LLC, Los Angeles, CA (US)

(21) Appl. No.: 19/030,545

(22) Filed: Jan. 17, 2025

Related U.S. Application Data
(60) Provisional application No. 63/622,173, filed on Jan. 18, 2024.

(51) Int. Cl. G06Q 50/20; G06F 21/32; G09B 5/06

(52) U.S. Cl. CPC G06Q 50/205; G06F 21/32; G09B 5/06

(57) ABSTRACT

A system which enables underprivileged youths to obtain important and pinpointed education geared toward real life lessons and leading the youths to avoid legal troubles while growing up is provided. At the same time, the system is designed to incentivize the youths on this path throughout their young years, resulting in the youths earning predetermined, incentivizing success funds. The system is designed to supplement the education accorded youths through the public school system and includes a series of age specific life education courses for accepted individuals. Upon completing each course while also remaining free of any serious legal entanglements, the individual will be issued a certificate of completion, along with a monetary credit in trust for future specified uses.

### FIELD OF THE INVENTION

The present invention pertains to the field of education and, more specifically, to implementing a system for educating youths, particularly underprivileged youths, through a series of fact based life lessons. If successfully completed by a youth at various stages of life while the youth avoids any serious legal trouble, the youth is entitled to receive a success fund for further education or other specified life pursuit purposes.

### BACKGROUND OF THE INVENTION

It is well recognized that individuals who grow up in underprivileged circumstances, whether in low income inner cities or poor rural areas, experience hardships and live under conditions which are simply not found or perhaps even fathomable by those who grow up in more prosperous regions. Many times, the hardships and conditions lead to temptations resulting in youths engaging in illegal activities which actually compounds the problem by further limiting possible future life opportunities. Many such illegal activities can result in prison time and a prison record. The experiences of prison and the resulting record can haunt individuals for the rest of their lives.

Not only is any given incarceration a liability for the individual, but to society as a whole. Although the exact number is not known, it is seemingly accepted that the cost of corrections in the United States is over $80 billion a year. However, this amount truly underestimates the real cost as it does not take into account related costs, such as social costs to affected family members and communities. Without a doubt, a system which incentivizes underprivileged youths through education to remain on the right side of the law, enabling them to stay out of prison and become proud contributors to society, would provide benefits to not only the youths themselves, but their families, communities and society in general.

### SUMMARY OF THE INVENTION

The present invention is concerned with providing a system which enables underprivileged youths to obtain important and pinpointed education geared toward real life lessons and leading the youths to avoid legal troubles while growing up. At the same time, the system is designed to incentivize the youths on this path throughout their young years, resulting in the youths earning predetermined success funds which can be used to further the lives of the youths while also benefitting society as a whole.

In accordance with certain embodiments of the invention, the system is designed to supplement the education accorded youths through the public school system and includes a series of age specific life education lessons for accepted individuals. Initially, a parent or legal guardian of an individual would need to apply to the program. To qualify, the individual must be of a beginning age group, such as between 5-10 years of age. In addition, eligibility requirements need to be met to appropriately assure that the youth is considered as underprivileged, such as children of families below the poverty line, on welfare, or the like. Once accepted, the youth will be issued a dedicated computing device, such as a tablet, with the youth having sole access through fingerprint, eye scan, facial recognition or the like verification techniques and the device being individually registered and certified. Although the educational materials may be pre-loaded on the device, it is preferred that the device has access to the internet to enable the education materials to be readily obtained through an authorized web portal to be downloaded and updated as needed.

In preferred embodiments, there is a minimum of 3-5 educational courses, with each course being directed to a specific age range during the life of the youth. For instance, one course could be directed to children 5-10 years of age; another course could be directed to youths 11-16 years of age; and a further course could be directed to individuals between the ages of 17-21 years. Each course is therefore geared to the age of the youth and specifically designed to instill a life lesson based on facts, with each lesson intending to instill a meaningful impression on the youth, helping to lead the individual down a growth path of a valuable citizen. While taking the course, eye recognition or other verification techniques will assure that the individual assigned to the particular device is, in fact, taking the course, with time and date information being automatically logged. Upon completing each course while remaining free of any serious legal entanglements, the individual will be issued a certificate of completion, along with a monetary credit in trust for future use once the entire program has been completed and the individual reaches legal age without ever being involved in any serious illegal activities. The trust fund will have stipulations on its use, such as limiting use to further education, job training, residential expenses, food and/or retirement investing.

Additional objects, features and advantages of the invention will become more readily apparent from the following detailed description of preferred embodiments which are not intended to be limiting but rather exemplary for the understanding of the overall invention.

### BRIEF DESCRIPTION OF THE DRAWING

FIG. 1 is a flow diagram indicating various stages of an incentivizes youth educational system in accordance with the invention.

### DETAILED DESCRIPTION OF THE INVENTION

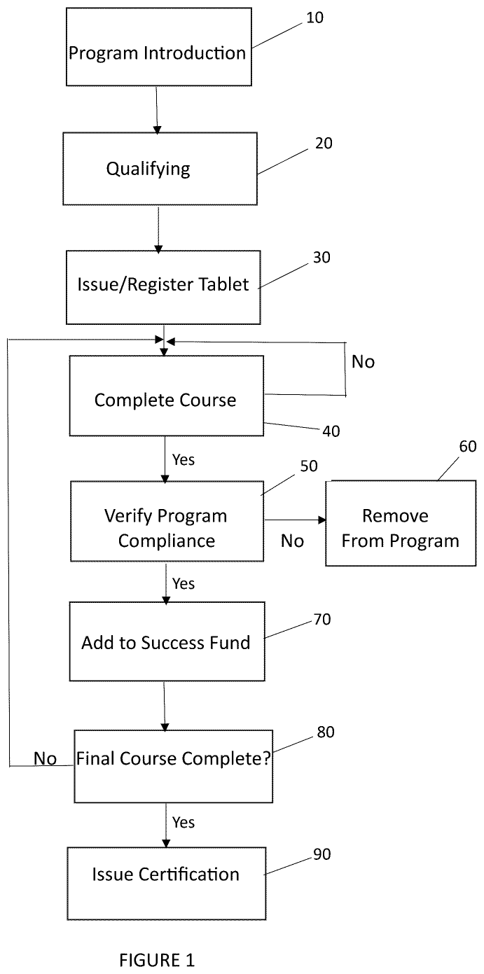

The educational system of the invention is designed to further enhance the education given to youths through the public school system and is particularly directed to provide education to underprivileged youths which are faced, at a very young age, with social and economic barriers to equal opportunities in life. This educational system is intended to instill further meaning, inspiration and hope into the lives of these individuals, shaping them to become respectable members of society while avoiding potential pitfalls which could result in issues with the law and damaging their future lives in unrealized ways. Although details and nuances of the system can vary from the preferred embodiments of the invention described below, the crux of the invention remains intact as generically indicated in the representative flowchart of FIG. 1.

As seen from FIG. 1, the first step 10 in this process is simply being introduced to the program. Certainly, this can be done in a myriad of ways, including government programs, infomercials, brochures, public school referrals, simple word of mouth or the like. Once interested in the program, signing up a particular individual requires satisfying various qualifications as represented in step 20. To quality, the individual should be of a beginning age group or stage, such as between 5-10 years of age. In addition, eligibility requirements need to be met to appropriately assure that the youth is considered as underprivileged, such as children of families below the poverty line, on welfare, or the like. In addition, the youth can have no significant juvenile record.

Assuming the youth meets the requisite qualifications, the individual is issued a computing device, at no cost to the individual/family, in step 30, such as an IPAD, ANDROID tablet, FIRE tablet or the like. Although the device can be internet ready, it is preferred that the tablet be dedicated for use with this educational program so as to not be capable of general internet access (although at least internet-based system update availability is desired). In addition, the computing device is specifically designed and registered for use by the particular youth to which it is assigned. To this end, issuing the device includes establishing sole access capabilities through fingerprint, eye scan, facial recognition, code, voice or the like verification techniques for the individual through the use of a fingerprint scanner, camera, microphone and/or the like built into the device. This verification is not only used to verify that nobody else is using the computing device or attending the educational sessions, but the particular individual is actually present and attentive for each given course, with added day, time and even location of use data being automatically and periodically logged. In this way, it can be effectively verified that the youth issued the particular device properly attended a given course and attendance can be verified. In addition, the device is of no use to another as it cannot be transferred or altered if lost or stolen and, upon reporting any such incident, the youth can be issued a new unit.

As indicated above, the number and type of course can vary in accordance with the invention. By way of example, there can be three courses, with each course being designed for a particular age group. For instance, the age groups could be classified with stage 1 being 5-10 year olds, stage 2 covering 11-16 year olds and stage 3 being 17-21 year olds. Regardless of the exact age classifications or number of stages, each available educational course is designed based on the age group. Using this exemplary age classification and the scenario of three courses, the first course is preferably geared to make the young individual think about the right thing to do under a particular set of circumstances in order to instill high morals. For example, the course could cover a scenario concerned with finding a purse or other object owned by someone else, why it is important to try and return it, and the resulting feeling of accomplishment and self-worth. The course could also cover topics of not taking something belonging to another, avoiding being disruptive in a school classroom, and respecting authority figures, including the police, teachers, and the like. Animations, music, interactive screens and the like are desirably used to engage the child. That is, at least at this early stage, it is considered that the more entertaining the curriculum, i.e., the program is more like a game than a lecture, the more attentive and focused the child will be.

In this scenario, the second course is more directed to middle and junior high school aged individuals. These individuals are considered to be a particularly vulnerable age group, encountering life decisions that could potentially negatively affect their entire futures. This course is slated to encompass at least bullying/intimidation, gangs, drugs, the prison system and perhaps even U.S. military recruitment. Here the course would again provoke thinking on a given topic and hopefully some personal perspective consideration. The second course is earmarked to be quite fact based, such as giving statistics on annual overdoses in America and data on effects of and death tolls attributable to the use of particular drugs, as well as in-depth analysis of the U.S. prison system including stats on percentages of inmates by race, typical life in prison, state versus federal prisons and the like. In general, this course is directed to making the right life choices in crucial youth years of life.

The third course can cover various topics, including job opportunities and annual incomes for people coming out of prison versus those who never go to prison, data on repeat offenders, and information on the operation and life in cartels. In addition, information on career opportunities and aptitude, higher education degrees with anticipated salaries, and careers in sports. Information can be given on investing, data on and tips from self-made millionaires, long term benefits of relationships and family, and the like. Basically, this third course is geared toward long term planning for the future, with a life outside of crime.

Referring back to FIG. 1, when the youth is proceeding through a given course, each time there is a login the program app knows if the course has been completed, i.e., the progress of the particular individual in the specified course. Once all the materials for a given course have been reviewed and the individual confirms course completion (step 40), the app moves to step 50 wherein there is a verification of program compliance. Verification step 50 is preferably quite comprehensive. For instance, at this point, it is to be verified that the youth has not gotten into any criminal mischief which would warrant removal from the program at step 60. If being removed, the individual, as well as the parent(s) or legal guardian(s) of the youth, would be notified and an opportunity for reconsideration would exist. However, the situation should actually be quite clear from school and juvenile records. With this in mind, it is desired to have school and law enforcement/legal personnel involved in this assessment. However, if the youth had remained out of trouble such that program compliance was verified in step 50, the process proceeds to step 70 wherein a monetary deposit would be made in a predetermined amount for the youth, i.e., a success fund. The funds could be placed in a revocable trust or other interest bearing account. In any case, the sources of these funds and the potential dispersion thereof will be detailed more fully below.

Next the process proceeds to step 80 wherein it is determined if all courses for the overall program have been completed. If not and the designated individual qualifies to move up a stage, the next course in the que is presented back at step 40. If the answer is yes, then the last contribution to the success fund will have already been deposited in the prior step 70 after a final verification step 50 is performed and the process proceeds to step 90. In step 90, an official certificate of completion is issued. At this point, the individual can return the computing device and will be entitled to ownership of the funds in accordance with the provisions of the program and trust. For instance, the trust can require the funds be only used for certain things, such as further education, job training, residential expenses, food and/or retirement investing. However, the possibility could also exist to enable the funds to be transferred to other relatives, friends or the like in need. In any case, the individual would have made it through the entire program and matured beyond an age likely to be newly induced into criminal activity.

The overall program would preferably be run and overseen by an agency or bureau established for this purpose. Still, the program could certainly benefit from input from a wide range of sources. For instance, the parents of the youths could have particular insights into local concerns and happenings, even problematic changes in various sectors, like drug use, crime or other important educational worthy issues. Based thereon, a website, social media or other communication avenue could be established that would enable parents and others to comment on the content of select educational material. Various other affected parties, like law enforcement personnel, can also provide comments and suggestions, relay relevant incidents in specific demographic areas, zip codes, etc., to the agency. Given the educational materials covered on crime and jail, input may be beneficially received from incarcerated or paroled individuals, who themselves could potentially benefit from the societal contribution being made. Public and/or private school members can provide important information on various topics, such as about any successful programs enacted on related topics like respect for teachers and bullying. Various levels of the government may have informed input on the education media material/topics. With the input in mind, the education materials can be tailored as appropriate, even to specific regions in which given youths live.

Based on the above, it should be clear that input to enhance the overall program can come from various sources and in different ways. In addition to a website, input or just overall communication can go through various social media platforms. Support can be given through ad pop-ups for companies or the like which may be sponsors of the program. This valued communication can also flow in the opposite direction, with the bureau or agency providing a platform to convey statistical or other information to the parents and youths of the program, as well as to relevant communities in general. AI can be effectively used in broadening the effectiveness of the communication.

Presumably there exist a host of philanthropists and companies willing to offer money to be used in funding this social/educational program. However, success of the program will undoubtably result in a reduction in the overall nationwide prison population and, correspondingly, the costs associated with running those prisons. Therefore, it is intended that the success funds can be paid from the money saved by the actual program such that, in accordance with an aspect of the invention, it is the government and society as a whole who will cover the costs. In fact, the savings may actually make it possible to provide further funding in the future to successful youths as a bonus for a clean record after, say, 3 or 5 years following full completion of the program. Furthermore, it is preferred that a database be established for the youths who successfully complete program, with the database being available to hiring companies and job recruiters.

Although described to reference to preferred aspects, embodiments and features of the invention, it should be understood that various changes and/or modifications can be made without departing from the invention. For instance, although an actual deposit was described as being made to the success fund after each course completion, a lump sum could be deposited at the end with earned amounts showing up on the tablet of the user to encourage further educational progress. In addition, it may be decided that, rather than a lump payment after completion of the program, monthly payments for a specified period of time would better aid the grown individuals in along successful life paths. Periodically or at certain stages of completion, ceremonies could also be conducted, enabling youths to be commended through testimonials, published honorary bio information or the like. Furthermore, although step 60 was disclosed in connection with completely removing a person from the program, it is possible that, depending on the circumstances surrounding any trouble the youth may find him/herself in, it is possible that provisions can be made for instead reducing the banked amount.

1. A method for incentivized education comprising:
providing a learning device configured for use by a qualified youth;
monitoring a progression of the youth through a first education course presented utilizing the learning device; and
upon verifying when the youth has completed the first education course, providing an incentivized reward for the benefit of the youth.

2. The method of claim 1 wherein, in evaluating for the qualified youth, at least two of age, status as underprivileged and no significant juvenile record requirements are considered.

3. The method of claim 1, further comprising, upon completion of the first education course, exposing the youth to additional, successively presented educational courses through the learning device.

4. The method of claim 3, further comprising classifying the youth into one of at least three age groups in determining a timing for exposing the youth to the additional educational courses.

5. The method of claim 4, wherein a topic of the first education course covers instilling proper morals and respect for others, a second education course covers bullying and dangers of drugs, and a third education course encompasses planning for a future with a life outside of crime.

6. The method of claim 1, wherein the incentivized reward is a financial reward.

7. The method of claim 6, wherein the financial reward is placed in a revocable trust.

8. The method of claim 7, wherein the revocable trust is not made available until the youth reaches a predetermined age.

9. The method of claim 8, wherein the revocable trust is only usable for specified purposes.

10. The method of claim 9, wherein the revocable trust can only be used for one or more of furthering education, job training, residential expenses, food and/or retirement investing.

11. The method of claim 1, wherein the learning device constitutes a computing device, such as a tablet, which is configured for use specifically in connection with the incentivized education.

12. The method of claim 11, wherein the computing device employs fingerprint, eye scan, facial recognition, code, voice or the like user verification technology.

13. The method of claim 12, further comprising tracking progression of the youth through the education course.

14. The method of claim 1, further comprising accepting input from outside sources in establishing educational content, including input from one or more of parents of the youth, teachers for the youth, law enforcement personnel, incarcerated individuals, government entities and news or social media people.

15. The method of claim 14, wherein the input is received through social networking or a dedicated website.

16. The method of claim 14, wherein the input includes providing local issue or news updates relevant to education course content.

17. A system configured to provide incentivized education to a qualified youth comprising:
a learning device configured for use by the qualified youth;
a monitoring unit configured to follow a progression of the youth through a first education course presented utilizing the learning device; and
an incentivized reward for the benefit of the youth upon verifying the youth has completed the first education course.

18. The system of claim 17, wherein the learning device comprises a computing device employing one or more of fingerprint, eye scan, facial recognition, code input and voice recognition as user verification technology and is configured to track progression of the youth through the education course.

19. The system of claim 17, further comprising a revocable trust established for the youth as the incentivized reward upon successful completion of the first education course.

20. The system of claim 17, wherein the system is configured to encompass as least three education courses each of which is based on a specified age group or stage of the youth, with at least the first education course covering instilling proper morals and respect for others, a second education course covering bullying and dangers of drugs, and a third education course encompassing planning for a future with a life outside of crime.
